(19) United States
(12) Patent Application Publication
(10) Pub. No.: US 2009/0250140 A1
(43) Pub. Date: Oct. 8, 2009

(54) Battery Plate Flash Dryer Oven With Self-Cleaning Feature

(76) Inventor: Terence L. Vetsch, West Allis, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/060,897

(22) Filed: Apr. 2, 2008

(51) Int. Cl. F27B 9/00

(52) U.S. Cl. 144/121

(57) ABSTRACT

An improved flash dryer oven is disclosed which operates in a self-cleaning manner that continuously removes dust and debris from the oven, thereby preventing dust and debris from interfering with the hot air flow through the oven. A self-cleaning function is provided to the flash dryer oven by routing the conveyor belt through the lower supply duct on its return path to continuously clean out lead oxide dust and particles that are located within the lower supply duct. In addition, the lower supply duct has a gabled top that will direct some of the lead oxide dust and particles off of the lower supply duct instead of the lead oxide dust and particles falling through nozzles in the top of the lower supply duct and into the lower supply duct.

### BACKGROUND OF THE INVENTION

### Field of the Invention

The present invention relates generally to industrial ovens, and more particularly to an improved flash dryer oven which operates in a self-cleaning manner that continuously removes dust and debris from the oven, thereby preventing dust and debris from interfering with the hot air flow through the oven.

Flash dryer ovens have been used in the manufacture of battery plates for lead-acid storage batteries such as those commonly used in automobiles. Such lead-acid storage batteries generally comprise a plurality of individual cells, each of which contains two or more battery plates that are separated by thin, porous separators. The battery plates consist of generally rectangular conductive supporting grid structures that are typically made of lead or a lead alloy. The grid structures contain and support an active battery paste material consisting of a mixture of lead oxide, sulfuric acid, and water, with dry additives such as fiber and expander optionally being added. The lead oxide reacts with the sulfuric acid to form mono-, tri- or tetrabasic lead sulfate(s). The mixture is dried and water is again added to form a paste having the desired consistency.

The lead oxide paste is applied to the grid structures by a pasting machine through which the unpasted grid structures are fed. After the grid structures have the lead oxide paste applied to them, they are fed into a flash drying oven to flash dry them. The grid structures are typically of a rectangular configuration with an electrically conductive tab extending from a location between the two upper corners. A battery stack is assembled from a plurality of the pasted grid structure battery plates, with adjacent battery plates being separated by segments of a separator material such as submicro polyethylene. Alternate battery plates are connected together to form the positive and negative sides of the battery, and the battery stack is placed into a battery case or container.

The flash drying operation is necessary in order to facilitate handling and processing of the pasted grid structures, with a flash drying oven typically drying or removing moisture from the outer layer or skin of the lead oxide paste. This strengthens and solidifies the outer “skin” of the lead oxide paste while the inner portion of the lead oxide paste will remain relatively soft and pliable and will retain substantial moisture. Typically, flash drying ovens fired with a direct gas flame are used to flash dry battery plates, with the battery plates being transported through the flash drying oven on an endless steel wire mesh conveyor belt.

A conventional flash dryer oven has top and bottom supply ducts extending the length of the oven to carry pumped (fan-driven) hot air (600-900 degrees F.) therethrough. The conveyor belt, which may be a heavy duty flat wire belting steel conveyor belt, carries the battery plates thereupon and travels between the top and bottom supply ducts, with a return path (not carrying the battery plates) being located below the flash dryer oven. The conveyor belt is porous to allow heat from the bottom supply duct to contact the bottom surface of the battery plates which ride upon and thereby contact the upper surface of the conveyor belt.

As those skilled in the art will immediately appreciate, during the flash drying process, particles of the lead oxide paste are left on the conveyor belt. These particles together with lead oxide dust from the dried lead oxide paste skin of the battery plates will be left in the flash dryer oven, and will fall into the lower supply duct, where the particles and dust build up and becomes caked on the bottom thereof. This buildup significantly impedes the flow of hot air through the lower supply duct, resulting in a substantial diminution in the drying capability of the flash dryer oven causing the battery plates to not dry evenly.

The operator of a flash dryer oven typically responds by turning up the temperature in the oven, which increases the cost of operation and shortens the life of the oven. While access doors are located in the sides of the lower supply duct to allow the lead oxide dust and particles in the lower supply duct to be cleaned out, doing so requires taking the flash dryer oven off-line, which operators are reluctant to do and, in fact, generally do not do. The lead oxide dust and particles have been found to accumulate to as much as nine inches in the twelve inch high lower supply duct, effectively substantially impeding the flow of hot air therethrough.

It will thus be appreciated that it would be desirable for a flash dryer oven to include an improved provision for the removal of lead oxide dust and particles which are deposited in the lower supply duct. It would further be desirable for the removal of lead oxide dust and particles to be accomplished without the need for operator intervention to initiate or facilitate such removal of lead oxide dust and particles. It would still further be desirable for the lead oxide dust and particles to be accomplished on a continuous basis to prevent the buildup of any lead oxide dust and particles in the lower supply duct.

It would also be desirable for the removal of the lead oxide dust and particles from the lower supply duct to be accomplished without the necessity of turning the flash dryer oven off, thereby precluding the necessity of taking the flash dryer oven out of production to clean out the lead oxide dust and particles in the lower supply duct. It would additionally be desirable to ensure that the removal of the lead oxide dust and particles from the lower supply duct not in any way interfere with the supply of hot air through the lower supply duct to dry battery plates passing through the flash dryer oven. It would further be desirable to collect the lead oxide dust and particles removed from the lower supply duct at a particular location from which they can periodically be removed and disposed of without stopping the operation of the flash dryer oven.

The self-cleaning flash dryer oven of the present invention must also be of construction which is both durable and long lasting, and it should also require little or no maintenance to be provided by the user throughout its operating lifetime. In order to enhance the market appeal of the self-cleaning flash dryer oven of the present invention, it should also be of inexpensive construction to thereby afford it the broadest possible market. Finally, it is also an objective that all of the aforesaid advantages and objectives be achieved by the self-cleaning flash dryer oven of the present invention without incurring any substantial relative disadvantage.

### SUMMARY OF THE INVENTION

The disadvantages and limitations of the background art discussed above are overcome by the present invention. With this invention, a self-cleaning flash dryer oven is described which departs from presently-known flash dryer ovens in two significant respects. The first, and more significant, of these changes is providing a self-cleaning function to the flash dryer oven by routing the conveyor belt through the lower supply duct on its return path to continuously clean out lead oxide dust and particles that are located within the lower supply duct. The second change is a redesign of the lower supply duct itself to provide a gabled top that will direct some of the lead oxide dust and particles off of the lower supply duct instead of the lead oxide dust and particles falling through nozzles in the top of the lower supply duct and into the lower supply duct.

The self-cleaning flash dryer oven of the present invention has upper and lower supply ducts which channel heated air onto battery plates as they are transported through the self-cleaning flash dryer oven by an endless conveyor belt on its conveyance path through the self-cleaning flash dryer oven. The upper supply duct is located above the conveyor belt and directs heated air downwardly onto battery plates carried on the conveyor belt, and the lower supply duct is located below the conveyor belt and directs heated air upwardly onto battery plates carried on the conveyor belt. The conveyor belt is made of heavy duty flat wire belting steel which allows heated air to flow therethrough.

Since the conveyor belt is endless, it necessarily must have a return path. The return path of the conveyor belt is directed through the bottom of the lower supply duct. The bottom of the lower supply duct, which is flat, is made of a heavier gauge, wear-resistant material such as steel, with the edges of the bottom angled upwardly at right angles to thereby create a slide bed in the bottom of the lower supply duct through which the conveyor belt moves in its return path. The opposite ends of the lower supply duct are open just enough to allow the conveyor belt to pass therethrough.

As the conveyor belt passes through the slide bed in the bottom of the lower supply duct, it will carry lead oxide dust and particles with it, thereby removing them from the lower supply duct and not allowing them to build up within the lower supply duct. By extending the slide bed to a point over a drawer, the lead oxide dust and particles will be deposited in the drawer by the movement of the conveyor belt. Thus, the self-cleaning flash dryer oven of the present invention will continuously clean out any lead oxide dust and particles contained in the lower supply duct, with no manual effort of the operator being required to do so.

The top side of the lower supply duct is also modified to have a gabled construction when viewed from either end of the lower supply duct. Nozzles are located in both sides of the top side of the lower supply duct. The gabled construction of the top side of the lower supply duct will act to direct at least some of the lead oxide dust and particles to either side of the lower supply ducts, with this portion of the lead oxide dust and particles then falling to the bottom of the interior of the self-cleaning flash dryer oven, where they will not substantially interfere with the flow of heated air within the self-cleaning flash dryer oven of the present invention. The lead oxide dust and particles located at the bottom of the interior of the self-cleaning flash dryer oven can periodically be cleaned out through access doors located in the sides of the self-cleaning flash dryer oven.

It may therefore be seen that the present invention teaches a self-cleaning flash dryer oven that includes an improved provision for the removal of lead oxide dust and particles which are deposited in the lower supply duct. The self-cleaning flash dryer oven of the present invention removes lead oxide dust and particles therefrom without the need for operator intervention to initiate or facilitate such removal of lead oxide dust and particles. The self-cleaning flash dryer oven of the present invention continuously removes the lead oxide dust and particles to prevent the buildup of any lead oxide dust and particles in the lower supply duct.

The self-cleaning flash dryer oven of the present invention accomplishes the removal of the lead oxide dust and particles from the lower supply duct without needing to be turned off, thereby precluding the necessity of taking it out of production. The self-cleaning flash dryer oven of the present invention also ensures that the removal of the lead oxide dust and particles from the lower supply duct does not in any way interfere with the supply of hot air through the lower supply duct to dry battery plates passing through the flash dryer oven. The lead oxide dust and particles removed from the lower supply duct are collected at a particular location from which they can periodically be removed and disposed of without stopping the operation of the flash dryer oven of the present invention.

The self-cleaning flash dryer oven of the present invention is of a construction which is both durable and long lasting, and which will require little or no maintenance to be provided by the user throughout its operating lifetime. The self-cleaning flash dryer oven of the present invention is also of inexpensive construction to enhance its market appeal and to thereby afford it the broadest possible market. Finally, all of the aforesaid advantages and objectives are achieved by the self-cleaning flash dryer oven of the present invention without incurring any substantial relative disadvantage.

### DESCRIPTION OF THE DRAWINGS

These and other advantages of the present invention are best understood with reference to the drawings, in which:

FIG. 1 is a perspective view of a flash dryer oven in which the self-cleaning feature of the present invention may be implemented;

FIG. 2 is a cutaway view of a previously known flash dryer oven showing many of the interior components thereof, including particularly the route traveled by an endless conveyor belt used to transport battery plates through the flash dryer oven;

FIG. 3 is a partial bottom plan view of an upper supply duct of the flash dryer oven illustrated in FIG. 2, showing a pluralty of nozzles located in the bottom side of the upper supply duct;

FIG. 4 is a partial top plan view of a lower supply duct of the flash dryer oven illustrated in FIG. 2, showing a pluralty of nozzles located in the top side of the lower supply duct;

FIG. 5 is a side plan view of the self-cleaning flash dryer oven of the present invention, showing in phantom lines the route traveled by an endless conveyor belt used to transport battery plates through the self-cleaning flash dryer oven;

FIG. 6 is a cutaway view of the self-cleaning flash dryer oven illustrated in FIG. 5, showing a lower supply duct that is modified to receive the conveyor belt in its return path to facilitate the removal of lead oxide dust and particles from the lower supply duct;

FIG. 7 is an enlarged cutaway view of the end of the self-cleaning flash dryer oven illustrated in FIGS. 5 and 6 through which battery plates enter the self-cleaning flash dryer oven, showing a cleanout drawer into which lead oxide dust and particles from the lower supply duct will be deposited by the conveyor belt;

FIG. 8 is an enlarged cutaway view of the end of the self-cleaning flash dryer oven illustrated in FIGS. 5 and 6 through which battery plates exit the self-cleaning flash dryer oven;

FIG. 9 is an isometric view of the ends of the upper and lower supply ducts illustrated in FIG. 7 and the path of the conveyor belt as it exits the lower supply duct and deposits lead oxide dust and particles from the lower supply duct into the cleanout drawer;

FIG. 10 is an end view of the end of the lower supply duct illustrated in FIG. 8;

FIG. 11 is a cross-sectional view of the upper and lower supply ducts illustrated in FIG. 9, showing the path of hot air thereinto; and

FIG. 12 is a top plan view of the lower supply duct illustrated in FIG. 9.

### DETAILED DESCRIPTION OF THE EXEMPLARY EMBODIMENTS

An exemplary embodiment of the self-cleaning flash dryer oven of the present invention will be presented herein. However, it is beneficial to first provide a brief discussion of the construction and operation of a conventional flash dryer oven, after which the points of departure therefrom by the self-cleaning flash dryer oven of the present invention may be discussed.

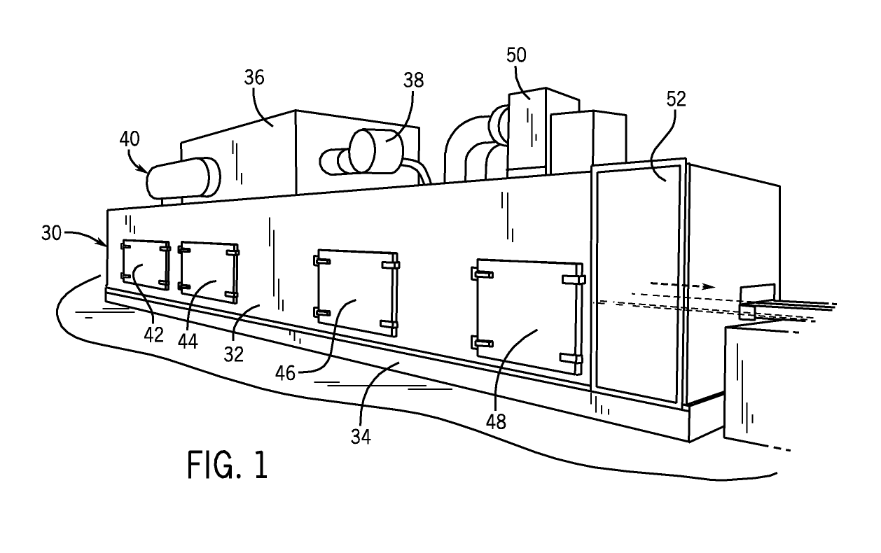

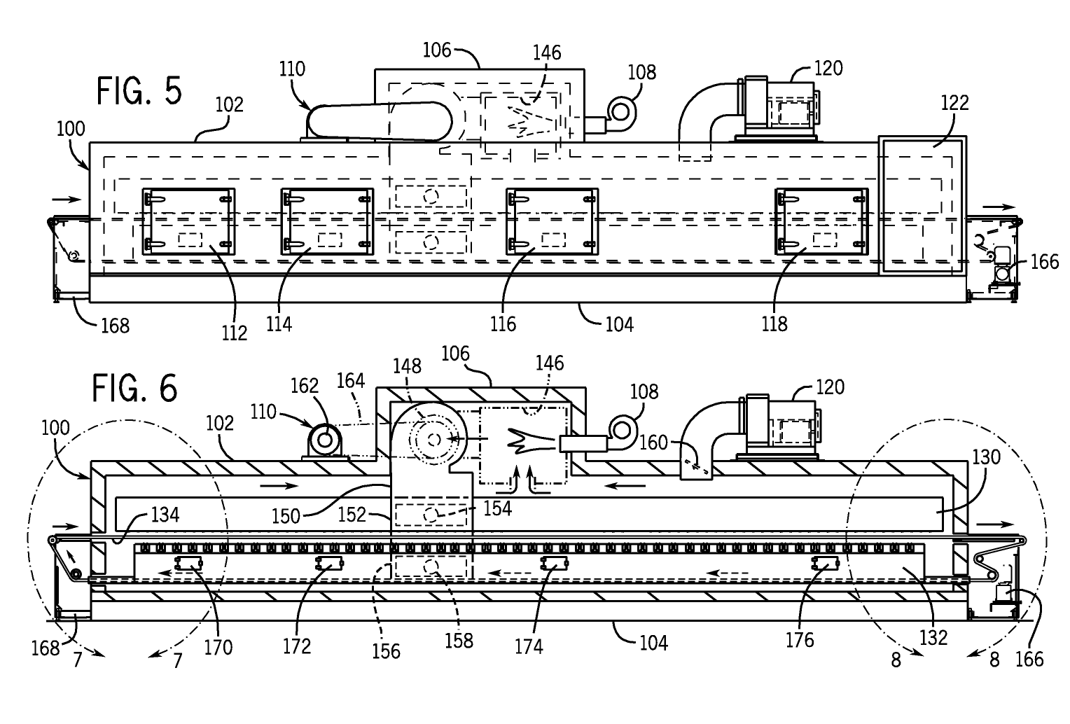

Referring first to FIG. 1, the exterior of a flash dryer oven 30 is illustrated from the perspective of its side and its outlet end. While the flash dryer oven 30 shown in FIG. 1 depicts a previously known flash dryer oven, it is also essentially identical in appearance from the outside thereof to the self-cleaning flash dryer oven of the present invention, as will become evident below in conjunction with the discussion of FIGS. 5 and 6. The flash dryer oven 30 has an oven housing 32 that is of rectangular configuration (and which is typically approximately thirty-one feet long by six feet wide by five feet high) and which is mounted on a base member 34.

The flash dryer oven 30 operates by having battery plates (not shown) pass through the flash dryer oven 30 from an inlet end (shown on the left in FIG. 1) to an outlet end (shown on the right in FIG. 1). The flash dryer oven 30 has a heating apparatus 36 located on top of the oven housing 32 near the midpoint thereof. The heating apparatus 36 has a gas burner 38 located at one end thereof, and a fan drive mechanism indicated generally by the reference numeral 40 located at the other end and at the side thereof.

Located on the side of the flash dryer oven 30 shown in FIG. 1 are four access doors 42, 44, 46, and 48, with it being understood that there are four additional access doors (which are not shown herein) on the other side of the flash dryer oven 30 in corresponding positions. The access doors 42, 44, 46, and 48 as well as the four access doors on the other side of the flash dryer oven 30 are used to provide access to the inside of the flash dryer oven 30. It will be understood by those skilled in the art that the oven housing 32, the heating apparatus 36, and access doors 42, 44, 46, and 48 as well as the four access doors on the other side of the flash dryer oven 30 are all well insulated to retain heat inside the flash dryer oven 30.

Located intermediate the heating apparatus 36 and the outlet end of the flash dryer oven 30 and on top of the flash dryer oven 30 is an exhaust fan 50, which operates to remove hot, moist air from the flash dryer oven 30. Located on the side of the flash dryer oven 30 shown in FIG. 1 near the outlet end thereof is a control panel 52 which contains the controls for operating the flash dryer oven 30. The flash dryer oven 30 may be heated with gas, and typically operates at approximately 650 degreed Fahrenheit.

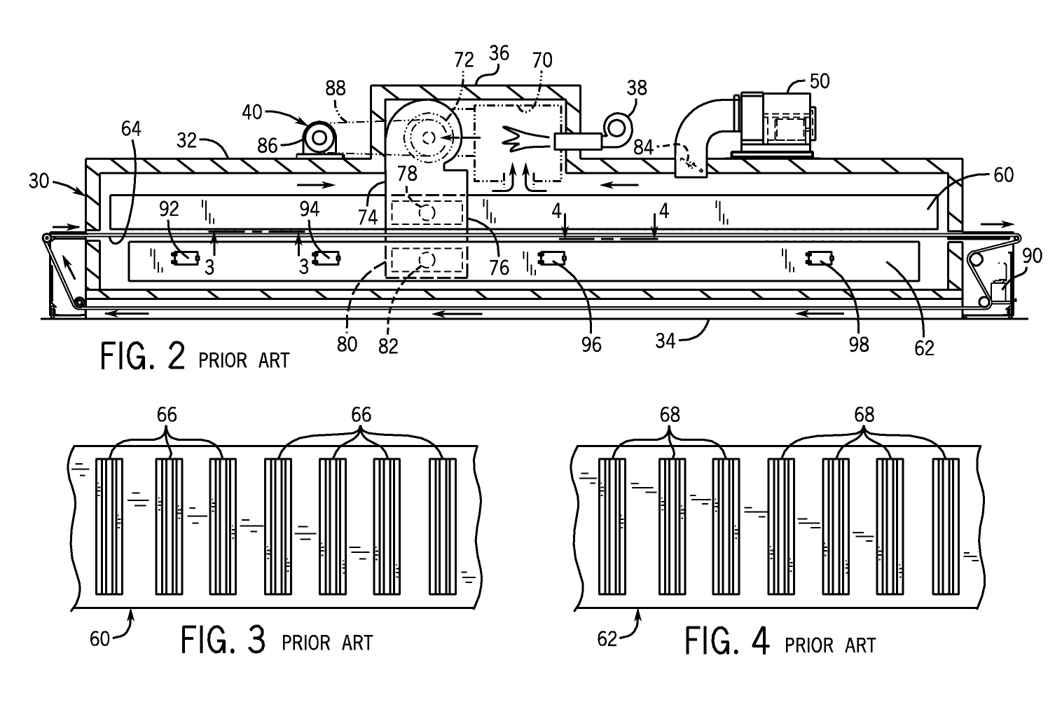

Referring now to the cutaway view of FIG. 2, the internal portions of the flash dryer oven 30 are shown and will now be discussed. Located inside the flash dryer oven 30 is an upper supply duct 60 and a lower supply duct 62, each of which extend for substantially the entire length of the interior of the flash dryer oven 30. It may be seen that the upper supply duct 60 and the lower supply duct 62 are spaced apart, with the conveyance path of a heavy duty flat wire belting steel endless conveyor belt 64 extending therebetween.

Referring now to FIGS. 2 and 3, the upper supply duct 60 is hollow and rectangular in cross-section, with closed ends. A plurality of laterally-oriented nozzles 66 are located on the otherwise flat bottom side of the upper supply duct 60. Each of the nozzles 66 are formed in the bottom of the upper supply duct 60 by a very wide laterally-oriented H-shaped cut, with the two segments cut on three sides thereof being folded outwardly to an angle of approximately fifty-five degrees to produce a gap of approximately five-sixteenths of an inch. The nozzles 66 are located approximately four inches apart along the length of the upper supply duct 60.

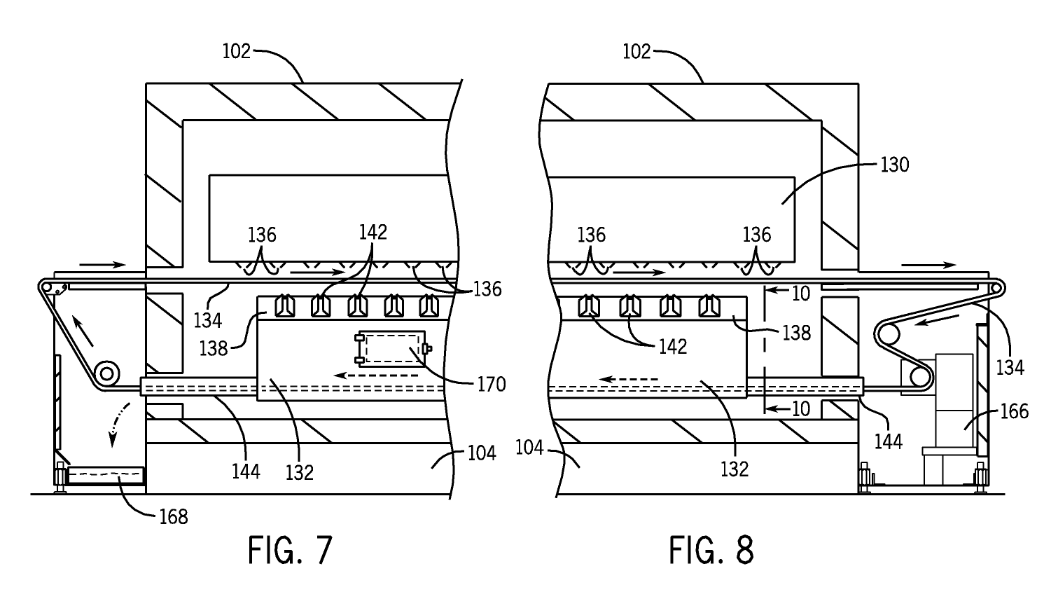

Referring now to FIGS. 2 and 4, the lower supply duct 62 is also hollow and rectangular in cross-section, with closed ends. A plurality of laterally-oriented nozzles 68 are located on the otherwise flat top side of the lower supply duct 62. Each of the nozzles 68 are formed in the top of the lower supply duct 62 by a very wide laterally-oriented H-shaped cut, with the two segments cut on three sides thereof being folded outwardly to an angle of approximately fifty-five degrees to produce a gap of approximately five-sixteenths of an inch. The nozzles 68 are located approximately four inches apart along the length of the lower supply duct 62. It should be noted that a different design for the lower supply duct 62 will be used in a preferred embodiment of the present invention, which will be discussed below in conjunction with FIGS. 5 through 12.

It may be seen in FIG. 2 that the heating apparatus 36 includes a firebox 70 into which the flame from the gas burner 38 projects. Heated air from the firebox 70 is drawn into a fan 72 also contained within the heating apparatus 36, with the fan 72 forcing the heated air into a “pants leg” distribution duct 74. The “pants leg” distribution duct 74 has a first distribution leg 76 located on one side of the interior of the flash dryer oven 30 and in fluid communication with the interior of the upper supply duct 60 through an aperture 78 in the side of the upper supply duct 60, and a second distribution leg 80 located on the other side of the interior of the flash dryer oven 30 and in fluid communication with the lower supply duct 62 through an aperture 82 in the side of the lower supply duct 62.

Heated air is thus supplied to the interiors of the upper supply duct 60 and the lower supply duct 62. Heated air from the upper supply duct 60 will be directed downwardly from the upper supply duct 60 through the nozzles 66 onto the top sides of battery plates (not shown) traveling through the flash dryer oven 30 on the conveyor belt 64. Similarly, heated air from the lower supply duct 62 will be directed upwardly from the lower supply duct 62 through the nozzles 68 onto the bottom sides of battery plates (not shown) traveling through the flash dryer oven 30 on the conveyor belt 64 (since the conveyor belt 64 is made of heavy duty flat wire belting, heated air can pass relatively unimpeded therethrough).

Heated air supplied from the upper supply duct 60 and the lower supply duct 62 is then recirculated back into the firebox 70 through in inlet in the bottom thereof. A small amount of moist heated air may be removed from the flash dryer oven 30 by the exhaust fan 50, which has a controlled vent 84 to control the exit of moist heated air from the flash dryer oven 30. The fan drive mechanism 40 includes an electric drive motor 86 and a belt drive 88.

The conveyor belt 64 has a return path located on the bottom of the flash dryer oven 30, within the base member 34. The conveyor belt 64 is driven by a motorized drive 90, with it being speed controlled to vary the amount of time it takes for battery plates (not shown) to pass through the flash dryer oven 30. Typically, it may take between ten and thirty seconds for the battery palates to pass through the flash dryer oven 30.

Those skilled in the art will appreciate that during the flash drying process, particles of lead oxide paste from the battery plates will be left on the conveyor belt 64. These particles together with lead oxide dust from the dried lead oxide paste skin of the battery plates will be left in the flash dryer oven 30, and will fall through the nozzles 68 into the lower supply duct 62, where the dust and particles will build up and become caked on the bottom of the lower supply duct 62. This buildup of dust and particles significantly impedes the flow of hot air through the lower supply duct 62, resulting in a substantial diminution in the drying capability of the flash dryer oven 30 causing uneven drying of the battery plates.

In presently-known the flash dryer ovens, cleanout doors are located in the sides of the lower supply duct 62. Four cleanout doors 92, 94, 96, and 98 are shown in FIG. 2 on the side of the lower supply duct 62, and additional cleanout doors could also be located on the other side of the lower supply duct 62 if desired. Access to the cleanout doors 92, 94, 96, and 98 is through the access doors 42, 44, 46, and 48 (shown in FIG. 1) in the oven housing 32 of the flash dryer oven 30, respectively. The cleanout doors 92, 94, 96, and 98 are used to clean out the dust and particles that have built up and become caked on the bottom of the lower supply duct 62. As mentioned above, this has been at best only a partially satisfactory solution.

Referring now to FIGS. 5, and 6, a self-cleaning flash dryer oven 100 is illustrated which is similar in external appearance to the flash dryer oven 30 illustrated in FIG. 1. The self-cleaning flash dryer oven 100 has an oven housing 102 that is of rectangular configuration (and which may be approximately thirty-one feet long by six feet wide by five feet high) and which is mounted on a base member 104. As shown in FIGS. 5 and 6, the self-cleaning flash dryer oven 100 has its inlet end shown on the left side thereof and its outlet end shown on the right side thereof. The self-cleaning flash dryer oven 100 has a heating apparatus 106 with a gas burner 108 and a fan drive mechanism 110 located on top of the oven housing 102 near the midpoint thereof.

Located on the side of the self-cleaning flash dryer oven 100 are four access doors 112, 114, 116, and 118, with four additional access doors (which are not shown herein) on the other side of the self-cleaning flash dryer oven 100 in corresponding positions. The access doors 42, 44, 46, and 48 and the four access doors on the other side of the fan drive mechanism 110 are well-insulated and are used to provide access to the inside of the fan drive mechanism 110. Located on top of the self-cleaning flash dryer oven 100 intermediate the outlet end thereof and the heating apparatus 106 is an exhaust fan the exhaust fan 120, and located on the side of the self-cleaning flash dryer oven 100 near the outlet end thereof is a control panel 122 which contains the controls for operating the self-cleaning flash dryer oven 100.

Referring now to the cutaway view of FIG. 6, the internal portions of the self-cleaning flash dryer oven 100 are shown and will now be discussed. Located inside the self-cleaning flash dryer oven 100 is an upper supply duct 130 and a lower supply duct 132, each of which extend for substantially the entire length of the interior of the self-cleaning flash dryer oven 100. It may be seen that the upper supply duct 130 and the lower supply duct 132 are spaced apart, with the conveyance path of a heavy duty flat wire belting steel endless conveyor belt 134 extending therebetween.

Referring now to FIGS. 6 through 8, the upper supply duct 130 shown therein is identical in construction to the upper supply duct 60 shown in FIG. 3. The upper supply duct 130 is hollow and rectangular in cross-section, with closed ends and a plurality of laterally-oriented nozzles 136 are located on the otherwise flat bottom side of the upper supply duct 130. Each of the nozzles 136 are formed in the bottom of the upper supply duct 130 by a very wide laterally-oriented H-shaped cut, with the two segments cut on three sides thereof being folded outwardly to an angle of approximately fifty-five degrees to produce a gap of approximately five-sixteenths of an inch. The nozzles 136 are located approximately four inches apart along the length of the upper supply duct 130.

Referring now to FIGS. 6 through 12, the lower supply duct 132, which differs from the construction of the lower supply duct 62 shown in FIG. 4, is also hollow. While the sides and bottom of the lower supply duct 132 are flat, the top of the lower supply duct 132 is gabled, with two flat, rectangular sections 138 and 140 extending from the respective sides of the lower supply duct 132 at angles of approximately one hundred three degrees and meeting at the top at an angle of approximately one hundred fifty-three degrees. In cross-section, the lower supply duct 132 may be approximately eighteen inches wide and fourteen inches tall.

A plurality of laterally-oriented nozzles 140 are located on the otherwise flat surfaces of each of the rectangular sections 138 and 140 forming the top side of the lower supply duct 132. Each of the nozzles 142 are formed by a wide laterally-oriented H-shaped cut, with the two segments cut on three sides thereof being folded outwardly to an angle of approximately fifty-five degrees to produce a gap of approximately five-sixteenths of an inch. The nozzles 142 are located approximately four inches apart along the length of each of the rectangular sections 138 and 140 of the lower supply duct 132, and extend above the surfaces of the rectangular sections 138 and 140 approximately one inch.

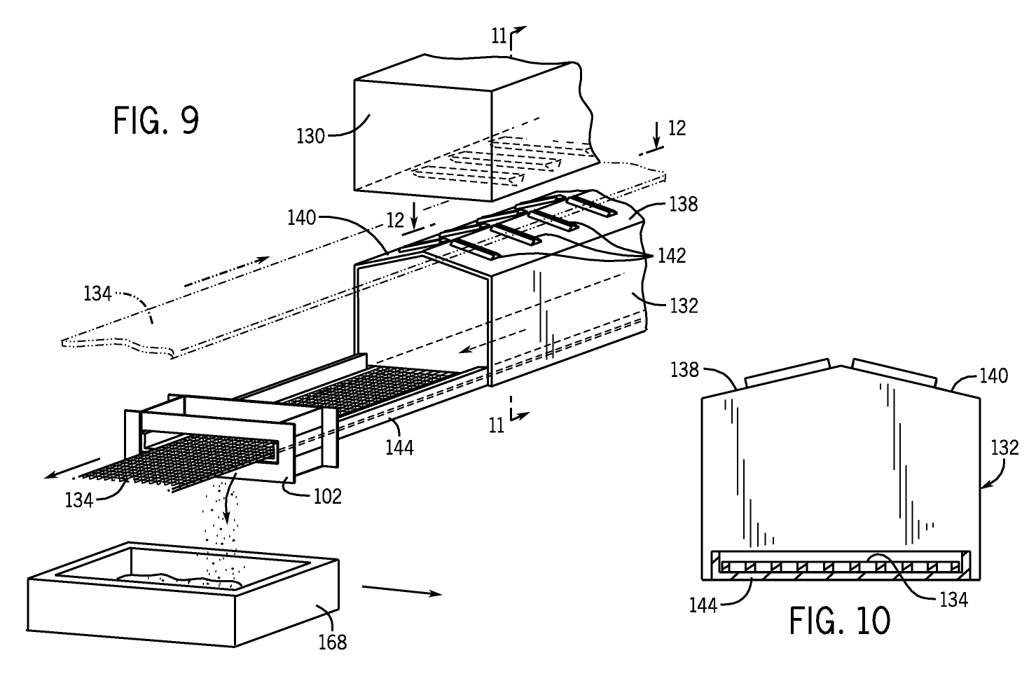

The bottom of the lower supply duct 132 is formed by a heavy-duty steel slide bed 144 that is approximately eighteen inches wide and has sides extending upwardly at right angles approximately two inches. By way of example, the slide bed 144 may be made of ten gauge steel while the rest of the lower supply duct 132 may be made of sixteen gauge aluminum. It may be seen particularly in FIGS. 9 and 10 that the conveyor belt 134 fits into the bottom of the slide bed 144 with only a small clearance on the sides of the conveyor belt 134. The slide bed 144 extends out of the ends of the lower supply duct 132 and the conveyor belt 134 passes through the lower supply duct 132, with the ends of the lower supply duct 132 being closed except for an appropriately-sized clearance above the top of the conveyor belt 134 to easily accommodate the conveyor belt 134 as it enters and exits the lower supply duct 132.

Referring now to FIG. 6, the heating apparatus 106 includes a firebox 146 into which the flame from the gas burner 108 projects. Heated air from the firebox 146 is drawn into a fan 148 also contained within the heating apparatus 106, with the fan 148 forcing the heated air into a “pants leg” distribution duct 150. The “pants leg” distribution duct 150 has a first distribution leg 152 located on one side of the interior of the self-cleaning flash dryer oven 100 and in fluid communication with the interior of the upper supply duct 130 through an aperture 154 in the side of the upper supply duct 130, and a second distribution leg 156 located on the other side of the interior of the self-cleaning flash dryer oven 100 and in fluid communication with the lower supply duct 132 through an aperture 158 in the side of the lower supply duct 132.

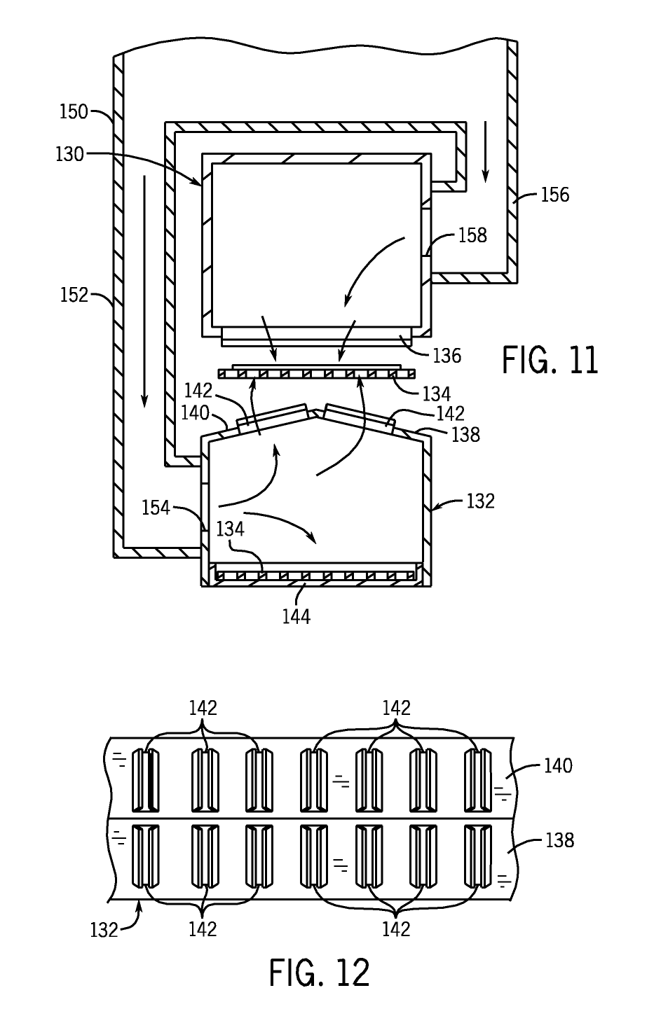

Referring now to FIG. 11, heated air is thus supplied to the interiors of the upper supply duct 130 and the lower supply duct 132. Heated air from the upper supply duct 130 will be directed downwardly from the upper supply duct 130 through the nozzles 136 onto the top sides of battery plates (not shown) traveling through the self-cleaning flash dryer oven 100 on the conveyor belt 134. Similarly, heated air from the lower supply duct 132 will be directed upwardly from the lower supply duct 132 through the nozzles 142 onto the bottom sides of battery plates (not shown) traveling through the self-cleaning flash dryer oven 100 on the conveyor belt 134 (heated air can pass relatively unimpeded through since the conveyor belt 134 is made of heavy duty flat wire belting).

Referring again to FIG. 6, heated air supplied from the upper supply duct 130 and the lower supply duct 132 is then recirculated back into the firebox 146 through in inlet in the bottom thereof. A small amount of moist heated air may be removed from the self-cleaning flash dryer oven 100 by the exhaust fan 120, which has a controlled vent 160 to control the exit of moist heated air from the self-cleaning flash dryer oven 100. The fan drive mechanism 110 includes an electric drive motor 162 and a belt drive 164.

The conveyor belt 134 is driven by a motorized drive 166, with it being speed controlled to vary the amount of time it takes for battery plates (not shown) to pass through the self-cleaning flash dryer oven 100. Typically, it may take between ten and thirty seconds for the battery palates to pass through the self-cleaning flash dryer oven 100. During the flash drying process, particles of lead oxide paste from the battery plates will be left on the conveyor belt 134. These particles together with lead oxide dust from the dried lead oxide paste skin of the battery plates will be left in the self-cleaning flash dryer oven 100, and while some will fall off of the gabled top of the lower supply duct 132, some will fall through the nozzles 142 into the lower supply duct 132.

Since the conveyor belt 134 of the self-cleaning flash dryer oven 100 has a return path located on the slide bed 144 within the lower supply duct 132, the conveyor belt 134 will continuously clean out lead oxide dust and particles from the lower supply duct 132. The lead oxide dust and particles will fall off of the slide bed 144 into a cleanout drawer 168 located at the inlet end of the self-cleaning flash dryer oven 100. The cleanout drawer 168 may periodically be emptied.

While most of the lead oxide dust and particles will thus be removed from the lower supply duct 132 in the self-cleaning operation described above, four cleanout doors 170, 172, 174, and 176 may be located in the sides of the lower supply duct 132, with additional cleanout doors optionally being located on the other side of the lower supply duct 132 if desired. Access to the cleanout doors 170, 172, 174, and 176 is through the access doors 112, 114, 116, and 118 (shown in FIG. 5) in the oven housing 102 of the self-cleaning flash dryer oven 100, respectively. The cleanout doors 170, 172, 174, and 176 may be used to clean out any dust and particles remaining in the lower supply duct 132 that have not been removed by the self-cleaning operation of the self-cleaning flash dryer oven 100.

It may therefore be appreciated from the above detailed description of the exemplary embodiments of the present invention that it teaches a self-cleaning flash dryer oven that includes an improved provision for the removal of lead oxide dust and particles which are deposited in the lower supply duct. The self-cleaning flash dryer oven of the present invention removes lead oxide dust and particles therefrom without the need for operator intervention to initiate or facilitate such removal of lead oxide dust and particles. The self-cleaning flash dryer oven of the present invention continuously removes the lead oxide dust and particles to prevent the buildup of any lead oxide dust and particles in the lower supply duct.

The self-cleaning flash dryer oven of the present invention accomplishes the removal of the lead oxide dust and particles from the lower supply duct without needing to be turned off, thereby precluding the necessity of taking it out of production. The self-cleaning flash dryer oven of the present invention also ensures that the removal of the lead oxide dust and particles from the lower supply duct does not in any way interfere with the supply of hot air through the lower supply duct to dry battery plates passing through the flash dryer oven. The lead oxide dust and particles removed from the lower supply duct are collected at a particular location from which they can periodically be removed and disposed of without stopping the operation of the flash dryer oven of the present invention.

The self-cleaning flash dryer oven of the present invention is of a construction which is both durable and long lasting, and which will require little or no maintenance to be provided by the user throughout its operating lifetime. The self-cleaning flash dryer oven of the present invention is also of inexpensive construction to enhance its market appeal and to thereby afford it the broadest possible market. Finally, all of the aforesaid advantages and objectives are achieved by the self-cleaning flash dryer oven of the present invention without incurring any substantial relative disadvantage.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. An oven for flash drying battery plates or the like, comprising:
an upper supply duct for supplying high temperature airflow therethrough, said upper supply duct having a pluralty of nozzles located in a bottom side thereof;
a lower supply duct for supplying high temperature airflow therethrough, said lower supply duct having a pluralty of nozzles located in a top side thereof and being located below said upper supply duct;
an endless conveyor belt for carrying battery plates or the like thereupon, said conveyor belt having a conveyance path which is located intermediate said bottom side of said upper supply duct and said top side of said lower supply duct such that said conveyor belt will carry the battery plates or the like on said conveyance path to flash dry the battery plates or the like; and
a slide bed forming the bottom of said lower supply duct, said conveyor belt having a return path through said lower supply duct on said slide bed whereby said conveyor belt removes dust and debris that would otherwise accumulate in said lower supply duct on said bottom thereof.

2. An oven as defined in claim 1, wherein said upper supply duct comprises:
a first hollow channel extending over a substantial portion of said conveyance path of said conveyor belt, said first hollow channel receiving a high temperature airflow and directing the high temperature airflow from nozzles contained on said bottom side thereof toward said conveyor belt;
and wherein said lower supply duct comprises:
a second hollow channel extending under a substantial portion of said conveyance path of said conveyor belt, said second hollow channel receiving a high temperature airflow and directing the high temperature airflow from nozzles contained on said top side thereof toward said conveyor belt.

3. An oven as defined in claim 2, wherein said nozzles contained on said bottom side of said first hollow channel and on said top side of said second hollow channel each comprise:
a laterally-oriented H-shaped cuts each defining two segments cut on three sides thereof, said two segments being folded outwardly at an angle of approximately fifty-five degrees.

4. An oven as defined in claim 2, wherein said first hollow channel is substantially rectangular in cross-section with closed ends and a substantially flat bottom in which a plurality of nozzles are located.

5. An oven as defined in claim 2, wherein said second hollow channel has sides extending upwardly from said slide bed, enclosed opposite ends that each include an opening sized to accommodate said conveyor belt as it enters and exits said lower supply duct, and a gabled top side comprising two flat, rectangular sections which extend from the tops of said sides of the lower supply duct at angles of approximately one hundred three degrees and meet at an angle of approximately one hundred fifty-three degrees.

6. An oven as defined in claim 5, wherein said nozzles are located in said flat, rectangular sections comprising said gabled top side of said second hollow channel.

7. An oven as defined in claim 1, wherein said conveyor belt is arranged and configured to allow a high temperature airflow from said nozzles of said lower supply duct to pass therethrough substantially unimpeded.

8. An oven as defined in claim 7, wherein said conveyor belt comprises:
a heavy duty flat wire belting steel conveyor belt.

9. An oven as defined in claim 1, wherein said slide bed is made of a heavy-duty material that will resist wear from said conveyor belt sliding thereupon.

10. An oven as defined in claim 9, wherein said slide bed is made from steel that is approximately ten gauge.

11. An oven as defined in claim 1, additionally comprising:
a storage compartment located under an end of said slide bed to catch dust and debris removed from said lower supply duct by said conveyor belt.

12. An oven as defined in claim 1, additionally comprising:
one or more cleanout doors located in at least one of the sides of said lower supply duct to provide access to clean out any dust and particles remaining in said lower supply duct that are not been removed by the operation of said oven.

13. An oven as defined in claim 1, additionally comprising:
a motorized drive for driving said conveyor belt, said motorized drive being speed controlled to vary the amount of time it takes said conveyor belt to carry battery plates or the like through said oven.

14. An oven for flash drying battery plates or the like, comprising:
an upper supply duct for supplying high temperature airflow therethrough, said upper supply duct having a pluralty of nozzles located in a bottom side thereof;
a lower supply duct for supplying high temperature airflow therethrough, said lower supply duct having a pluralty of nozzles located in a top side thereof and being located below said upper supply duct, said top side of said lower supply duct being gabled;
an endless conveyor belt for carrying battery plates or the like thereupon, said conveyor belt having a conveyance path which is located below said bottom side of said upper supply duct and above said top side of said lower supply duct such that said conveyor belt will carry the battery plates or the like on said conveyance path to flash dry the battery plates or the like, said conveyor belt being arranged and configured to allow a high temperature airflow from said nozzles of said lower supply duct to pass therethrough substantially unimpeded;
a slide bed forming the bottom of said lower supply duct, said conveyor belt having a return path through said lower supply duct on said slide bed whereby said conveyor belt removes dust and debris that would otherwise accumulate in said lower supply duct on said bottom thereof, said slide bed being made of a heavy-duty material that will resist wear from said conveyor belt sliding thereupon; and
a storage compartment located under an end of said slide bed to catch dust and debris removed from said lower supply duct by said conveyor belt.

15. An oven for flash drying battery plates or the like, comprising:
an upper supply duct for supplying high temperature airflow therethrough, said upper supply duct having a pluralty of nozzles located in a bottom side thereof;
a lower supply duct for supplying high temperature airflow therethrough, said lower supply duct having a pluralty of nozzles located in a top side thereof and being located below said upper supply duct; and
an endless conveyor belt for carrying battery plates or the like thereupon, said conveyor belt having a conveyance path which is located intermediate said bottom side of said upper supply duct and said top side of said lower supply duct such that said conveyor belt will carry the battery plates or the like on said conveyance path to flash dry the battery plates or the like, said conveyor belt having a return path through said lower supply duct whereby said conveyor belt removes dust and debris that would otherwise accumulate in said lower supply duct on said bottom thereof.

16. An oven as defined in claim 15, wherein said lower supply duct has a gabled top side comprising two adjacent flat, rectangular sections which extend from the tops of said sides of the lower supply duct.

17. An oven as defined in claim 15, wherein said slide bed is made of a heavy-duty material that will resist wear from said conveyor belt sliding thereupon.

18. An oven as defined in claim 15, additionally comprising:
a storage compartment located under an end of said slide bed to catch dust and debris removed from said lower supply duct by said conveyor belt

19. An oven as defined in claim 15, additionally comprising:
a variable speed motorized drive for driving said conveyor belt.

20. A method of operating an oven for flash drying battery plates or the like, said method comprising:
supplying high temperature airflow through an upper supply duct for having a pluralty of nozzles located in a bottom side thereof and a lower supply duct having a pluralty of nozzles located in a top side thereof, said lower supply duct being located below said upper supply duct;
carrying battery plates or the like upon an endless conveyor belt having a conveyance path which is located intermediate said bottom side of said upper supply duct and said top side of said lower supply duct to flash dry the battery plates or the like; and
providing a return path for said conveyor belt through said lower supply duct on a slide bed which forms the bottom of said lower supply duct, whereby said conveyor belt removes dust and debris that would otherwise accumulate in said lower supply duct on said bottom thereof.
